(19) United States
(12) Patent Application Publication
(10) Pub. No.: US 2016/0314269 A1
(43) Pub. Date: Oct. 27, 2016

(54) SYSTEM AND METHOD FOR PROVIDING AN INTERACTIVE AVATAR SUBSTANCE ABUSE PROGRAM ASSISTANT

(71) Applicant: Gloria Manley, Scottsdale, AZ (US)

(72) Inventor: Gloria Manley, Scottsdale, AZ (US)

(21) Appl. No.: 15/136,928

(22) Filed: Apr. 24, 2016

Related U.S. Application Data
(60) Provisional application No. 62/152,895, filed on Apr. 26, 2015.

(51) Int. Cl. G06F 19/00; G06F 3/0484; H04L 29/06; G06F 9/44; G06F 3/0481

(52) U.S. Cl. CPC G06F 19/3418; G06F 9/4446; G06F 3/04815; H04L 65/403; G06F 3/04842; G06F 19/322; G06F 19/3481

(57) ABSTRACT

The present invention generally relates to systems and methods for providing an outpatient type substance abuse program via software as a service (SaaS) methodologies. Specifically, embodiments of the present invention provide systems and methods for providing customized SaaS applications configured to host 12-week intensive outpatient type substance abuse programs. Preferred embodiments of the present invention utilize 3-D avatars to expand treatment activities into virtual reality experiences while keeping identities of clients anonymous. Further, preferred embodiments of the present invention utilize a cloud hosted architecture and data encryption capable of satisfying regulatory compliance concerns (e.g., Health Insurance Portability and Accountability Act (HIPAA)).

### CROSS-REFERENCE TO RELATED APPLICATIONS

This application claims the benefit of U.S. Provisional Patent Application No. 62/152,895, filed Apr. 24, 2015 and entitled “SYSTEM AND METHOD FOR PROVIDING AN INTERACTIVE AVATAR SUBSTANCE ABUSE PROGRAM ASSISTANT” the entire disclosure of which is incorporated herein by reference.

### FIELD OF THE INVENTION

The present invention generally relates to systems and methods for providing an outpatient type substance abuse program via software as a service (SaaS) methodologies. Specifically, embodiments of the present invention provide systems and methods for providing customized SaaS applications configured to host 12-week intensive outpatient type substance abuse programs. Preferred embodiments of the present invention utilize 3-D avatars to expand treatment activities into virtual reality experiences while keeping identities of clients anonymous. Further, preferred embodiments of the present invention utilize a cloud hosted architecture and data encryption capable of satisfying regulatory compliance concerns (e.g., Health Insurance Portability and Accountability Act (HIPAA)).

### BACKGROUND

Rehabilitation of individuals suffering with substance abuse or other illnesses or ailments requiring outpatient treatment generally requires the individual to be serviced by therapist and other healthcare providers located in the vicinity of that individual. Individuals will go to rehabilitation centers or other specific locations in order to receive treatment and therapy as necessary to help them deal with their ongoing needs.

While rehabilitation centers may be useful for those individuals where such facilities are readily available, there are numerous geographic areas that have limited or no access to such facilities. This leaves a gap where those with substance abuse issues who need outpatient treatment cannot find or receive convenient adequate treatment as they are required to travel in order to receive such treatment. In some cases, especially where an individual is located in a rural or sparse suburban area, the distances the individual must travel can be prohibitive, costly and time consuming. These factors weigh heavily in whether an individual will actually commit to travelling to receive such treatment, and failure to do so can result in relapses or other significant health and mental issues in the individual.

Another complication with in person outpatient treatment is the stigma of being an individual suffering from substance abuse. When treatment is provided in person to a patient, that patient is faced with challenges associated with lack of anonymity. Individuals can feel judged, or otherwise have anxiety about attending in person outpatient treatments and treatment facilities.

Therefore, there is a need in the art for a system and method for providing an outpatient type substance abuse program via software as a service (SaaS) methodologies. These and other features and advantages of the present invention will be explained and will become obvious to one skilled in the art through review of the present application.

### SUMMARY OF THE INVENTION

Accordingly, embodiments of the present invention are directed at a providing system and method for providing an outpatient type substance abuse program via software as a service (SaaS) methodologies.

According to an embodiment of the present invention, a system for providing an interactive avatar substance abuse program assistant comprises: a computer processor; a non-volatile computer-readable memory; and a circuitry for providing a communications means, wherein said computer processor, non-volatile computer-readable memory and circuitry for providing a communications means are communicatively connected and the non-volatile computer-readable memory is configured with computer instructions configured to cause said computer processor and circuitry for providing said communications means to: receive a contact request from a user related to provision of an avatar based substance abuse program; identify said user from information contained in said contact request; retrieve user data associated with said user identified in said contact request; retrieve user avatar information associated with said user; initiate contact with one or more therapist located remotely to said user and connected to said system via a remote computing device; retrieve therapist avatar information associated with at least one contacted therapist; generate graphical representation of a 3D environment; generate a user avatar from said user avatar information and a therapist avatar from said therapist avatar information; incorporate user avatar and therapist avatar into said 3D environment; and provide control over user avatar to user and control over therapist avatar to said at least one therapist.

According to an embodiment of the present invention non-volatile computer-readable memory is configured with computer instructions configured to further cause said computer processor and circuitry for providing said communications means to: provide 3D environment incorporating user avatar and therapist avatar to both user and at least one therapist; receive continuous input from user related to utilization of user avatar; receive continuous input from at least one therapist related to the utilization of therapist avatar; process inputs and generate actions for user avatar based on input from user and actions for therapist avatar based on input from at least one therapist; implement said actions for user avatar and therapist avatar in said 3D environment incorporating user avatar and therapist avatar; provide continuous updated 3D environment to both user and at least one therapist.

According to an embodiment of the present invention, the non-volatile computer-readable memory is configured with computer instructions configured to further cause said computer processor and circuitry for providing said communications means to: generate a therapy information data set from actions taken by user and at least one therapist associated with their respective avatars and interactions therebetween in the 3D environment; and store said therapy information data set.

According to an embodiment of the present invention, a method for providing an interactive avatar substance abuse program assistant comprises the steps of: receiving a contact request from a user related to provision of an avatar based substance abuse program; identifying said user from information contained in said contact request; retrieving user data associated with said user identified in said contact request; retrieving user avatar information associated with said user; initiating contact with one or more therapist located remotely to said user and connected to said system via a remote computing device; retrieving therapist avatar information associated with at least one contacted therapist; generating graphical representation of a 3D environment; generating a user avatar from said user avatar information and a therapist avatar from said therapist avatar information; incorporating user avatar and therapist avatar into said 3D environment; and providing control over user avatar to user and control over therapist avatar to said at least one therapist.

According to an embodiment of the present invention, the method further comprises the steps of: providing 3D environment incorporating user avatar and therapist avatar to both user and at least one therapist; receiving continuous input from user related to utilization of user avatar; receiving continuous input from at least one therapist related to the utilization of therapist avatar; processing inputs and generate actions for user avatar based on input from user and actions for therapist avatar based on input from at least one therapist; implementing said actions for user avatar and therapist avatar in said 3D environment incorporating user avatar and therapist avatar; providing continuous updated 3D environment to both user and at least one therapist.

According to an embodiment of the present invention, the method further comprises the steps of: generating a therapy information data set from actions taken by user and at least one therapist associated with their respective avatars and interactions therebetween in the 3D environment; and storing said therapy information data set.

According to an embodiment of the present invention, a system for providing an interactive avatar substance abuse program assistant comprises: a computer processor; a non-volatile computer-readable memory; a 3D generation module; a therapy engagement module; and a circuitry for providing a communications means, wherein said computer processor, non-volatile computer-readable memory and circuitry for providing a communications means are communicatively connected and the 3D generation module, therapy engagement module and non-volatile computer-readable memory is configured with computer instructions configured to cause said computer processor and circuitry for providing said communications means to: receive a contact request from a user related to provision of an avatar based substance abuse program; identify said user from information contained in said contact request; retrieve user data associated with said user identified in said contact request; retrieve user avatar information associated with said user; initiate contact with one or more therapist located remotely to said user and connected to said system via a remote computing device; retrieve therapist avatar information associated with at least one contacted therapist; generate graphical representation of a 3D environment; generate a user avatar from said user avatar information and a therapist avatar from said therapist avatar information; incorporate user avatar and therapist avatar into said 3D environment; and provide control over user avatar to user and control over therapist avatar to said at least one therapist.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 is an illustration of an exemplary process flow, in accordance with an embodiment of the present invention;

FIG. 3 is an illustration of an exemplary process flow, in accordance with an embodiment of the present invention;

FIG. 4 is an illustration of a network diagram for a cloud based portion of the system, in accordance with an embodiment of the present invention;

FIG. 5 is an illustration of a network diagram for a cloud based portion of the system, in accordance with an embodiment of the present invention;

FIG. 6 illustrates a schematic overview of an embodiment of a system for providing outpatient type substance abuse program via software as a service (SaaS) methodologies, in accordance with an embodiment of the present invention; and

FIG. 7 illustrates a schematic overview of an embodiment of a system for providing outpatient type substance abuse program via software as a service (SaaS) methodologies, in accordance with an embodiment of the present invention.

### DETAILED SPECIFICATION

The present invention generally relates to systems and methods for providing an outpatient type substance abuse program via software as a service (SaaS) methodologies. Specifically, embodiments of the present invention provide systems and methods for providing customized SaaS applications configured to host 12-week intensive outpatient type substance abuse programs. Preferred embodiments of the present invention utilize 3-D avatars to expand treatment activities into virtual reality experiences while keeping identities of clients anonymous. Further, preferred embodiments of the present invention utilize a cloud hosted architecture and data encryption capable of satisfying regulatory compliance concerns (e.g., Health Insurance Portability and Accountability Act (HIPAA)).

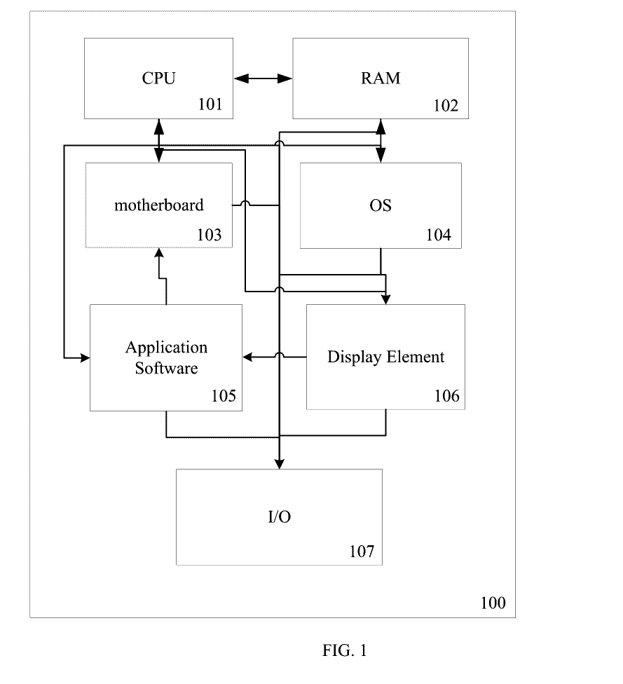

According to an embodiment of the present invention, the system and method shares data to and may be used in conjunction or through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106 and one or more input/output devices/means 107. Examples of computing devices usable with embodiments of the present invention include, but are not limited to, personal computers, smartphones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

According to an embodiment of the present invention, the system is configured to provide providing substance abuse and other mental health treatment utilizing a SaaS architecture in order to allow for patients who would otherwise not be able to, or it would be inconvenient for those patients to, go to a standard mental healthcare facility for treatment. Further embodiments are useful for providing these services in an outpatient format, where in person meeting with a care giver or therapist is not generally as critical. While embodiments of the present invention will be discussed herein with respect to the substance abuse perspective, one of ordinary skill in the art would appreciate that the same systems and methods described herein with respect to substance abuse treatment could also be utilized for treatment of numerous other physiological and psychological complications (e.g., Post Traumatic Stress Disorder (PTSD), Traumatic Brain Injuries (TBI), Attention Deficit Hyperactivity Disorder (ADHD)). Embodiments of the present invention are contemplated for use with treatments of these and other such physiological and psychological disorders and complications.

In a preferred embodiment, the system provides an interface whereby users and healthcare providers can interact with one another in a 3-D setting using virtual avatars to represent the participants in an interactive environment in real or near real time. Avatars may be generated by the system either independent from the actual physical characteristics of a user or through replicating features of that user from data provided to the system. Data provided to the system may be, for instance, but not limited to, by way of text input or option selection via a graphical user interface, by way of image capture from an image capture device (e.g., web camera, digital camera, camera on a smartphone), voice capture via an audio device (e.g., audio headset, microphone) or any combination thereof. One of ordinary skill in the art would appreciate that there are numerous types of data that could be provided to and utilized by the system in the generation of avatars for users and therapists or other healthcare providers, as well as numerous methods and systems for capturing and providing such data. Embodiments of the present invention are contemplated for use with any appropriate type and means for capture of such data for use in generating avatars by the system.

According to an embodiment of the present invention, once the data required to generate the avatar for the appropriate parties (e.g., user and therapist) is acquired, the system is further configured to provide an interactive 3-D world or area where each party may interact with the other(s) in order to receive/provide appropriate treatment or counseling. Advantageously, the parties may be located remotely from one another and still feel as though they are in an intimate and personal setting. This interaction allows for a more engaged treatment or counseling session than if the participant was merely being provided treatment over the phone or other limited remote medium.

According to an embodiment of the present invention, the system is configured to provide the interactive 3-D world and avatar information to the computing devices of both the user and the therapist or other service provider. In certain embodiments, multiple users, multiple therapists and/or multiple service providers may be connected into the same interactive 3-D world. For instance, the system may provide an interactive 3-D world where one or more therapist and one or more users could join in collectively to receive a virtual group therapy session. Similarly, a single user and single therapist could be connected in order to conduct a one-on-one therapy session. One of ordinary skill in the art would appreciate that there are numerous scenarios that could be utilized and recreated by joining one or more users with one or more therapists or other service providers in order to provide a variety of treatment methodologies, and embodiments of the present invention are contemplated for use with these scenarios.

According to an embodiment of the present invention, the system is configured to utilize encryption and secure transmission protocols to ensure the transmission and receipt of confidential health information is maintained as such when being communicated between the system and the various users and service providers connected to the system. In certain embodiments, the system may provide access to or connect to third-party systems in order to retrieve relevant electronic health record (EHR) information associated with one or more users. In this manner, the system can assist with the streamlining of the treatment process by retrieving information that may be relevant to a therapist with respect to the conditions and history of the patient/user.

According to an embodiment of the present invention, all communications between the user and the system and the system and the therapist are secured via one or more encryption or other cryptographic means. This ensures that all communications remain confidential and the parties can interact as if they were in the privacy of the therapist's or other service provider's private office.

According to an embodiment of the present invention, the system may be configured to allow for users to be connected with therapist both in a scheduled manner (e.g., at a specific time) and/or in an on demand manner (e.g., user can request the system connect them to a therapist at any given time). Advantageously, the system can be configured to serve regularly scheduled therapy sessions as well as be available for use by users in a crisis or other emergent scenario. This allows for users to be able to receive help when and where they need it, at all times.

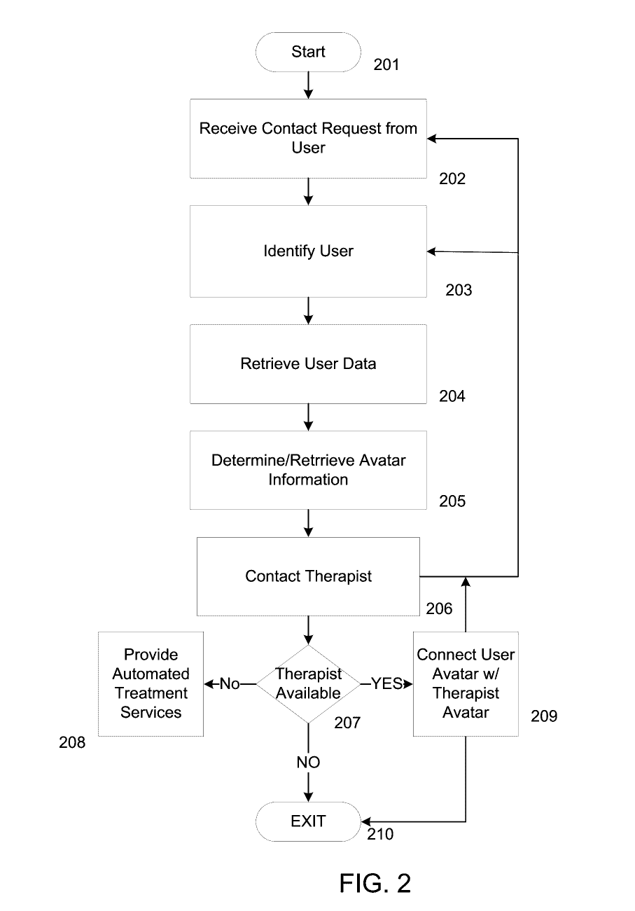

Turning now to FIG. 2, an illustration of an exemplary process flow, in accordance with an embodiment of the present invention, is shown. At step 201, the process starts with a user contacting the system for the provision of therapy services.

At step 202, the system receives the contact request from the user and sets about processing the request in order to efficiently provide the requested services. At step 203, the system identifies the user. This can be accomplished, for instance, via matching login information provided by the user with information stored by the system. Login information may include, but is not limited to, username/password pairs, biometric information, single sign-on information, rolling code from a key FOB, or any combination thereof. One of ordinary skill in the art would appreciate that there are numerous methods for providing logins for a user, and embodiments of the present invention are contemplated for use with any appropriate login methodology.

At step 204, the system retrieves user data associated with the logged in user. User data may include, but is not limited to, associated service provider information (e.g., identifiers associated with the service provider(s)), user identification information (e.g., name, age, gender, location, time zone), user therapeutic history or other EHR information, or any combination thereof. One of ordinary skill in the art would appreciate that there are numerous types of user data that could be stored and retrieved by the system, and embodiments of the present invention are contemplated for use with any appropriate user data.

At step 205, the system retrieves avatar information and determines the appropriate avatar for the user based on the information retrieved. As described herein, the avatar may be derived from information previously provided by the user, whether via input or capture data, and generated based on that information.

At step 206, the system attempts contacts the appropriate therapist. This may be accomplished, for instance, by way of sending a push notification or other real time communication to the therapist noting that the user is ready for a treatment session. In other embodiments, the therapist may receive an email, text message or other communication, with a link or other interactive feature allowing the therapist to launch the appropriate application or browser and enter the treatment session.

At step 207, the system determines if both parties are available. In most cases, this will mean the therapist as the user is generally the one logging onto the system for provision of therapy services. However, in certain embodiments, the system may allow for the therapist to reach out to the user for a session.

If the therapist (or user) is available, the system connects the user and the therapist avatars together in a predetermined or selected 3-D interactive world. In this place, the therapist and user may conduct their session in real-time or near real-time. At this point the process terminates at step 210.

At step 208, if the therapist is not available, the user may be connected to automated treatment services or to another therapist. This is most likely to occur when a user is seeking emergent treatment. In this case, the system may contact other therapists associated with the user via user data or EHR data, or connect the user to any available therapists. In this manner, the system provides a virtual “on call” therapist that can provide services at a moment's notice.

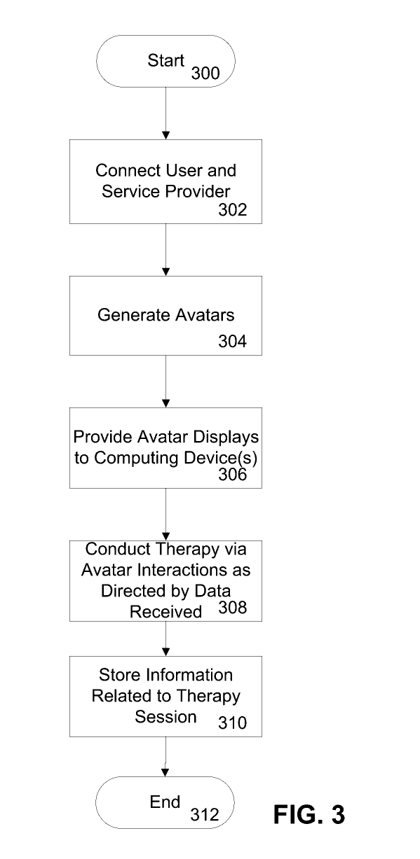

Turning now to FIG. 3, an illustration of an exemplary process flow, in accordance with an embodiment of the present invention, is shown. At step 300, the process starts with the engagement of the system by the user. At step 302, the system connects the user to a service provider (e.g., therapist).

At step 304, the system generates the appropriate avatars for both the user and the service provider. As described herein, the avatars may be generated based on user input or service provider input. At step 306, the system provides the avatars and 3-D interactive world to the computing devices of the user and service provider. As previously discussed, the computing devices could be any manner of computing device (e.g., laptop, desktop, smartphone, tablet PC, smart TV).

At step 308, the system allows the user and service provider to conduct their session by receiving and transmitting data (e.g., in a streaming manner), preferably through a secured and/or encrypted connection, allowing for the maintenance of privacy and security with respect to these communications.

At step 310, the system may store information about the therapy session, such as notes taken by the service provider during the session. Other information that may be stored include, but is not limited to, duration of session, a recording of the session, notes taken by the user, follow up plans, scheduling events for future sessions made during the therapy session, or any combination thereof. One of ordinary skill in the art would appreciate that there are numerous types of information that may be recorded and stored, and embodiments of the present invention are contemplated for use with any appropriate information types. At this point, the process terminates at step 312.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

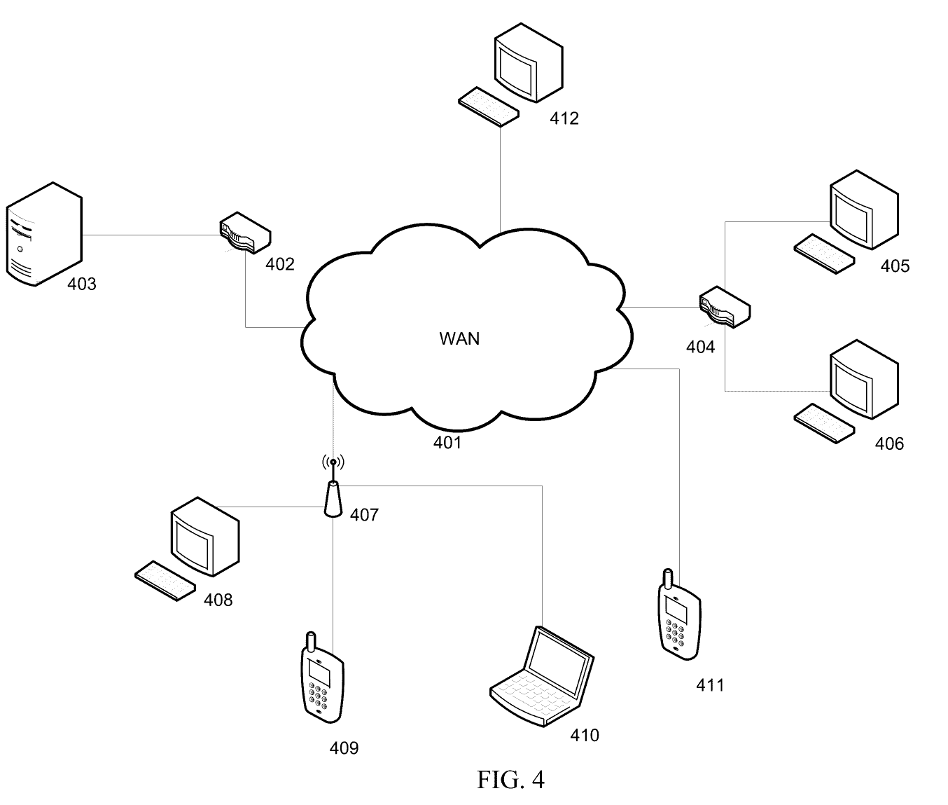

Referring to FIG. 4, a schematic overview of a cloud based system in accordance with an embodiment of the present invention is shown. The cloud based system is comprised of one or more application servers 403 for electronically storing information used by the system. Applications in the application server 403 may retrieve and manipulate information in storage devices and exchange information through a Network 401 (e.g., the Internet, a LAN, WiFi, Bluetooth, etc.). Applications in server 403 may also be used to manipulate information stored remotely and process and analyze data stored remotely across a Network 401 (e.g., the Internet, a LAN, WiFi, Bluetooth, etc.).

According to an exemplary embodiment, as shown in FIG. 4, exchange of information through the Network 401 may occur through one or more high speed connections. In some cases, high speed connections may be over-the-air (OTA), passed through networked systems, directly connected to one or more Networks 401 or directed through one or more routers 402. Router(s) 402 are completely optional and other embodiments in accordance with the present invention may or may not utilize one or more routers 402. One of ordinary skill in the art would appreciate that there are numerous ways server 403 may connect to Network 401 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 403 via Network 401 or other network in numerous ways. For instance, a component may connect to the system i) through a computing device 412 directly connected to the Network 401, ii) through a computing device 405, 406 connected to the WAN 401 through a routing device 404, iii) through a computing device 408, 409, 410 connected to a wireless access point 407 or iv) through a computing device 411 via a wireless connection (e.g., CDMA, GMS, 3G, 4G) to the Network 401. One of ordinary skill in the art would appreciate that there are numerous ways that a component may connect to server 403 via Network 401, and embodiments of the present invention are contemplated for use with any method for connecting to server 403 via Network 401. Furthermore, server 403 could be comprised of a personal computing device, such as a smartphone, acting as a host for other computing devices to connect to.

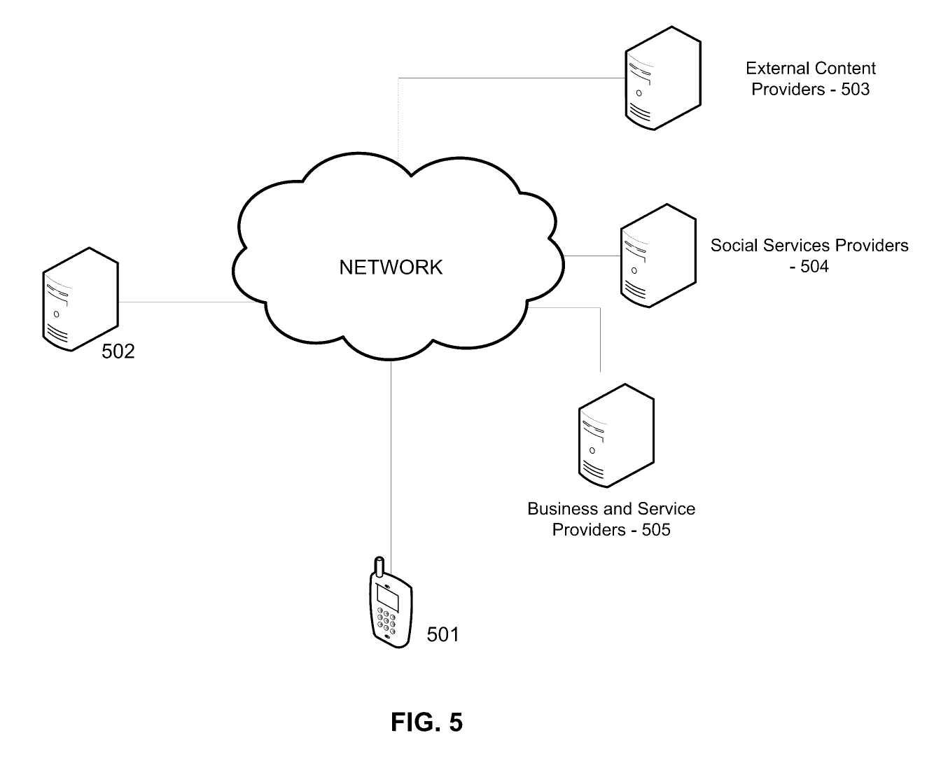

Turning now to FIG. 5, a continued schematic overview of a cloud based system in accordance with an embodiment of the present invention is shown. In FIG. 5, the cloud based system is shown as it may interact with users and other third party networks or APIs. For instance, a user of a mobile device 501 may be able to connect to application server 502. Application server 502 may be able to enhance or otherwise provide additional services to the user by requesting and receiving information from one or more of an external content provider API/website or other third party system 503, a social services provider 504, one or more business and service providers 505 or any combination thereof. Additionally, application server 502 may be able to enhance or otherwise provide additional services to an external content provider API/website or other third party system 503, a social services provider 504, or one or more business and service providers 505 by providing information to those entities that is stored on a database that is connected to the application server 502. One of ordinary skill in the art would appreciate how accessing one or more third-party systems could augment the ability of the system described herein, and embodiments of the present invention are contemplated for use with any third-party system.

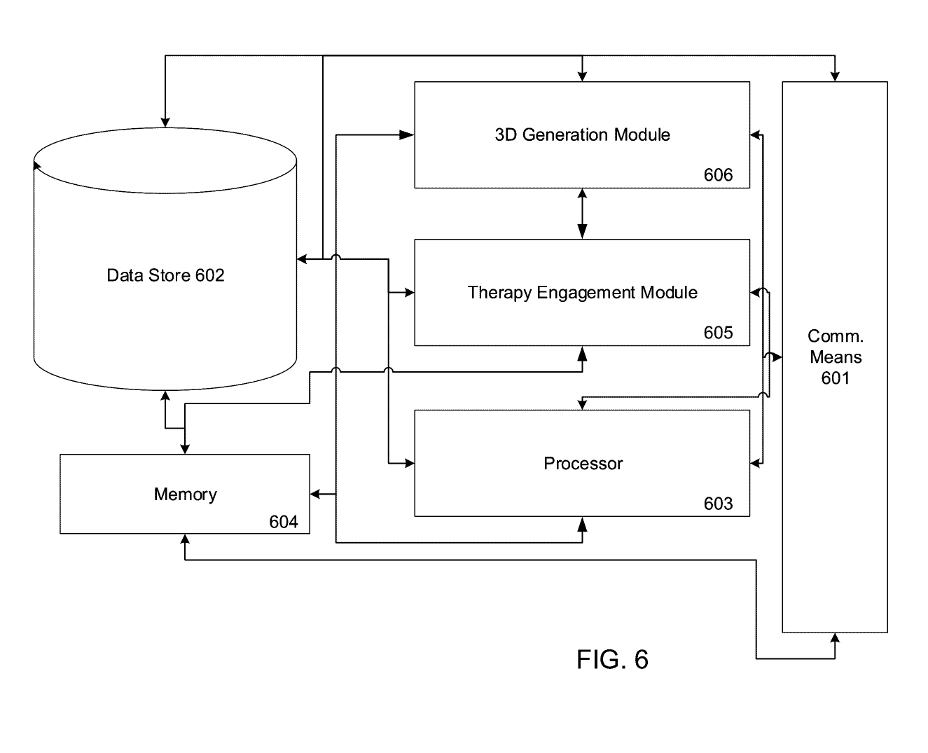

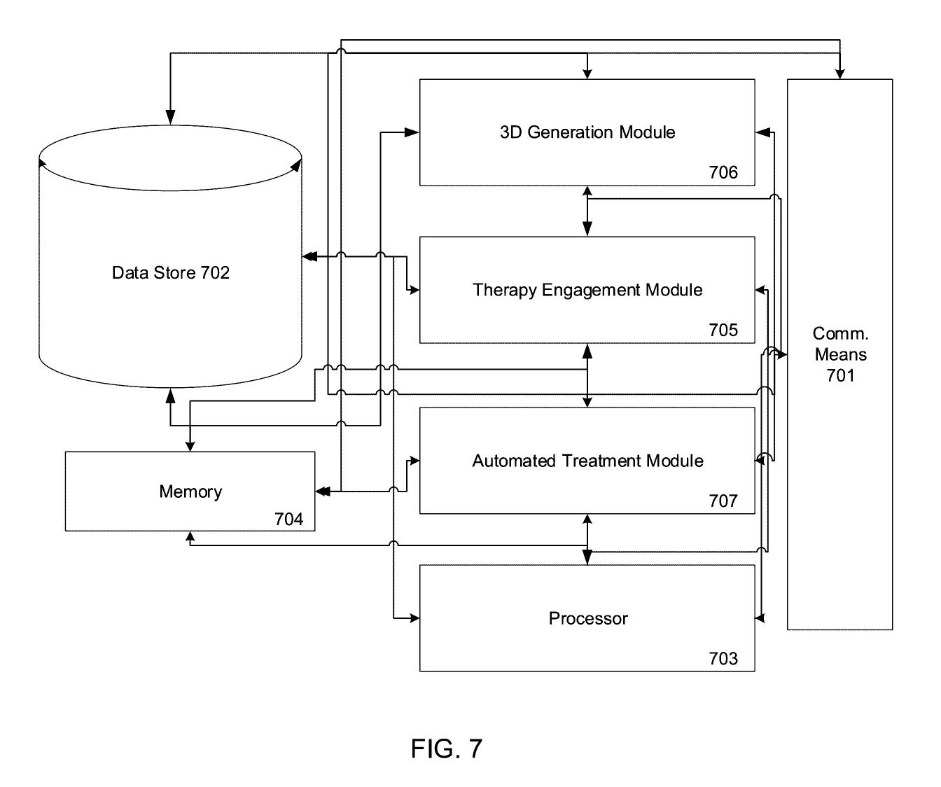

Turning to FIG. 6, according to an embodiment of the present invention, a system for providing an outpatient type substance abuse program via software as a service (SaaS) methodologies is comprised of one or more communications means 601, one or more data stores 602, a processor 603, memory 604, a 3D generation module 605 and therapy engagement module 606. FIG. 7 shows an alternative embodiment of the present invention, comprised of one or more communications means 701, one or more data stores 702, a processor 703, memory 704, a 3D generation module 705 therapy engagement module 706, and an automated treatment module 707. The various modules described herein provide functionality to the system, but the features described and functionality provided may be distributed in any number of modules, depending on various implementation strategies. One of ordinary skill in the art would appreciate that the system may be operable with any number of modules, depending on implementation, and embodiments of the present invention are contemplated for use with any such division or combination of modules as required by any particular implementation. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data, voice or video communications over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

According to an embodiment of the present invention, the 3D generation module is configured to provide rendering for the 3D environment utilized by embodiments of the present invention. The 3D generation module takes data received from a data store, communications means or other data source and utilizes the data to generate and model an appropriate 3D environment. The 3D environment can simulate any real world environment a therapist or individual may desire for the provision of treatment. For instance, a therapist may request that the 3D generation module generate and provide for rendering a representation of a therapist's office. In other cases, the therapist may prefer to have the 3D generation module generate and provide for rendering a serene setting, such as a forest or a field. The selection of an environment to be generated by the 3D generation module may be made by the therapist, the individual seeking treatment, or a combination of both. For instance, an individual suffering from agoraphobia may decline a therapist's selection of an outdoor or open environment that may otherwise scare or cause bad feelings in the individual.

According to an embodiment of the present invention, aside from generating the environment, the 3D generation module is configured to retrieve avatar information and generate avatars for both the individual(s) receiving treatment and the therapist(s) providing treatment. As noted elsewhere herein, the appearance of the avatars may be selected and amended by individuals and therapists to represent the appearance they desire. The 3D generation module is involved in the process for both generating and amending the appearance of avatars as well as inserting the avatars into the 3D environment and allowing both the individual receiving treatment and the therapists to control and interact with the 3D environment. In general, this is effected through a communications link being provided between the 3D generation module and computing devices of participants in the 3D environment. A communications link could be provided via a socket, a tunnel, or other communications link between devices via communications means and methods. One of ordinary skill in the art would appreciate that there are numerous methods for creating and maintaining such links, and embodiments of the present invention are contemplated for use with any such methods.

According to an embodiment of the present invention, the therapy engagement module is configured to handle the services associated with identifying and linking individuals with therapists, as detailed elsewhere herein. The therapy engagement module allows for contacts to be made by individuals and the communication requests and links to be made to one or more therapists for the provision of the therapy services. In preferred embodiments, the therapy engagement module ensures that individuals are linked up with appropriate therapists (e.g., therapist qualified to handle issues specific to the individual seeking treatment). In further embodiments, where a therapist may not be available, the therapy engagement module may also be configured to engage with the automated treatment module in order to connect the individual seeking treatment with the appropriate automated treatment system.

According to an embodiment of the present invention, the automated treatment module is configured to be engaged when an appropriate therapist is not available or otherwise where an individual seeking treatment would prefer an automated process (e.g., those with social issues). In this manner, the system can provide services to individuals, even when live therapists are not available, such as in times where demand is high (e.g., holiday seasons). The automated treatment module may be configured to use various artificial intelligence (AI) routines, or other activities (e.g., video games, interactive puzzles, literature) in order to provide treatment in a manner other than that being provided for by a therapist.

According to an embodiment of the present invention, the automated treatment module, in provision of automated treatment, may engage with the 3D generation module in order to have a 3D environment generated and the automated treatment module may be configured to select and be entered into the 3D environment as an avatar. In this manner, the individual will be provided services as if a real therapist was there, but instead the services are rendered via an AI system.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, Python, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various specialized systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing an interactive avatar substance abuse program assistant, said system comprising:
a computer processor;
a non-volatile computer-readable memory; and
a circuitry for providing a communications means,
wherein said computer processor, non-volatile computer-readable memory and circuitry for providing a communications means are communicatively connected and the non-volatile computer-readable memory is configured with computer instructions configured to cause said computer processor and circuitry for providing said communications means to:
receive a contact request from a user related to provision of an avatar based substance abuse program;
identify said user from information contained in said contact request;
retrieve user data associated with said user identified in said contact request;
retrieve user avatar information associated with said user;
initiate contact with one or more therapist located remotely to said user and connected to said system via a remote computing device;
retrieve therapist avatar information associated with at least one contacted therapist;
generate graphical representation of a 3D environment;
generate a user avatar from said user avatar information and a therapist avatar from said therapist avatar information;
incorporate user avatar and therapist avatar into said 3D environment; and
provide control over user avatar to user and control over therapist avatar to said at least one therapist.

2. The system of claim 1, wherein said non-volatile computer-readable memory is configured with computer instructions configured to further cause said computer processor and circuitry for providing said communications means to:
provide 3D environment incorporating user avatar and therapist avatar to both user and at least one therapist;
receive continuous input from user related to utilization of user avatar;
receive continuous input from at least one therapist related to the utilization of therapist avatar;
process inputs and generate actions for user avatar based on input from user and actions for therapist avatar based on input from at least one therapist;
implement said actions for user avatar and therapist avatar in said 3D environment incorporating user avatar and therapist avatar;
provide continuous updated 3D environment to both user and at least one therapist.

3. The system of claim 1, wherein said non-volatile computer-readable memory is configured with computer instructions configured to further cause said computer processor and circuitry for providing said communications means to:
generate a therapy information data set from actions taken by user and at least one therapist associated with their respective avatars and interactions therebetween in the 3D environment; and
store said therapy information data set.

4. The method for providing an interactive avatar substance abuse program assistant, said method comprising the steps of:
receiving a contact request from a user related to provision of an avatar based substance abuse program;
identifying said user from information contained in said contact request;
retrieving user data associated with said user identified in said contact request;
retrieving user avatar information associated with said user;
initiating contact with one or more therapist located remotely to said user and connected to said system via a remote computing device;
retrieving therapist avatar information associated with at least one contacted therapist;
generating graphical representation of a 3D environment;
generating a user avatar from said user avatar information and a therapist avatar from said therapist avatar information;
incorporating user avatar and therapist avatar into said 3D environment; and
providing control over user avatar to user and control over therapist avatar to said at least one therapist.

5. The method of claim 4, further comprising the steps of:
providing 3D environment incorporating user avatar and therapist avatar to both user and at least one therapist;
receiving continuous input from user related to utilization of user avatar;
receiving continuous input from at least one therapist related to the utilization of therapist avatar;
processing inputs and generate actions for user avatar based on input from user and actions for therapist avatar based on input from at least one therapist;
implementing said actions for user avatar and therapist avatar in said 3D environment incorporating user avatar and therapist avatar;
providing continuous updated 3D environment to both user and at least one therapist.

6. The method of claim 4, further comprising the steps of:
generating a therapy information data set from actions taken by user and at least one therapist associated with their respective avatars and interactions therebetween in the 3D environment; and
storing said therapy information data set.

7. A system for providing an interactive avatar substance abuse program assistant, said system comprising:
a computer processor;
a non-volatile computer-readable memory;
a 3D generation module;
a therapy engagement module; and
a circuitry for providing a communications means,
wherein said computer processor, non-volatile computer-readable memory and circuitry for providing a communications means are communicatively connected and the 3D generation module, therapy engagement module and non-volatile computer-readable memory is configured with computer instructions configured to cause said computer processor and circuitry for providing said communications means to:
receive a contact request from a user related to provision of an avatar based substance abuse program;
identify said user from information contained in said contact request;
retrieve user data associated with said user identified in said contact request;
retrieve user avatar information associated with said user;
initiate contact with one or more therapist located remotely to said user and connected to said system via a remote computing device;
retrieve therapist avatar information associated with at least one contacted therapist;
generate graphical representation of a 3D environment;
generate a user avatar from said user avatar information and a therapist avatar from said therapist avatar information;
incorporate user avatar and therapist avatar into said 3D environment; and
provide control over user avatar to user and control over therapist avatar to said at least one therapist.

8. The system of claim 7, wherein said non-volatile computer-readable memory is configured with computer instructions configured to further cause said computer processor and circuitry for providing said communications means to:
provide 3D environment incorporating user avatar and therapist avatar to both user and at least one therapist;
receive continuous input from user related to utilization of user avatar;
receive continuous input from at least one therapist related to the utilization of therapist avatar;
process inputs and generate actions for user avatar based on input from user and actions for therapist avatar based on input from at least one therapist;
implement said actions for user avatar and therapist avatar in said 3D environment incorporating user avatar and therapist avatar;
provide continuous updated 3D environment to both user and at least one therapist.

9. The system of claim 7, wherein said non-volatile computer-readable memory is configured with computer instructions configured to further cause said computer processor and circuitry for providing said communications means to:
generate a therapy information data set from actions taken by user and at least one therapist associated with their respective avatars and interactions therebetween in the 3D environment; and
store said therapy information data set.

10. The system of claim 7, wherein said system further comprises an automated treatment module.
